(19) United States
(12) Patent Application Publication
(10) Pub. No.: US 2020/0251966 A1
(43) Pub. Date: Aug. 6, 2020

(54) MOTOR MODULE, AND ELECTRIC POWER STEERING DEVICE

(71) Applicant: Nidec Corporation, Kyoto (JP)

(72) Inventors: Shuji ENDO, Kyoto (JP); Hiromitsu OHASHI, Kyoto (JP)

(21) Appl. No.: 16/649,155

(22) PCT Filed: Oct. 5, 2018
(86) PCT No.: PCT/JP2018/037427

§ 371 Date: Mar. 20, 2020

Related U.S. Application Data
(60) Provisional application No. 62/568,993, filed on Oct. 6, 2017.

(30) Foreign Application Priority Data
Jan. 24, 2018 (JP) 2018-009706

(51) Int. Cl. H02K 11/33; H02K 9/22; B62D 5/04

(52) U.S. Cl. CPC H02K 11/33; H02K 9/22; H02K 2213/06; H02K 2211/03; B62D 5/046

(57) ABSTRACT

A motor module includes a motor including n-phase windings where n is 3 or more, a first circuit boar, a first inverter mounted on the first circuit board and connected to the windings, a first passive element group mounted on the first circuit board, a first heat sink in thermal contact with the first circuit board, a second circuit board, a second inverter mounted on the second circuit board and connected to the windings, and a second passive element group mounted on the second circuit board. A first passive element having a highest height in the first passive element group and a second passive element having a highest height in the second passive element group are located between the first circuit board and the second circuit board, and do not overlap each other when viewed along a direction of a rotation axis of a rotor of the motor.

### CROSS REFERENCE TO RELATED APPLICATIONS

This is a U.S. national stage of PCT Application No. PCT/JP2018/037427, filed on Oct. 5, 2018, and priority under 35 U.S.C. § 119(a) and 35 U.S.C. § 365(b) is claimed from US Provisional Application No. 62/568,993, filed Oct. 6, 2017 and Japanese Application No. 2018-009706, filed Jan. 24, 2018; the entire disclosures of which are hereby incorporated herein by reference.

### 1. FIELD OF THE INVENTION

The present disclosure relates to a motor module and an electric power steering device.

### 2. BACKGROUND

Recently, an electromechanically integrated motor in which an electric motor (hereinafter simply referred to as a “motor”), a power conversion device that converts power from a power supply into power to be supplied to the motor, and an electronic control unit (ECU) are integrated has been developed. Particularly in the in-vehicle field, high quality assurance is required from the viewpoint of safety. Therefore, a redundant design has been adopted in which a safe operation can be continued even when some of parts fail. As an example of the redundant design, to provide two power conversion devices for one motor has been studied.

JP 5177711 B discloses a motor module including: a motor having a pair of coil sets; a pair of inverter circuits that supply power to the pair of coil sets; a pair of pre-drivers connected to the pair of inverter circuits; and a microcontroller that controls the pair of pre-drivers. Such a configuration in JP 5177711 B in which the pair of inverter circuits are connected to the pair of coil sets is referred to as a “double inverter configuration” in the present specification. The motor module of JP 5177711 B includes a power circuit board and a control circuit board. Passive elements, such as a smoothing capacitor and a choke coil, are mounted on the power circuit board, and control circuits such as the microcontroller and the pre-driver, are mounted on the control circuit board.

JP 2017-191093 A discloses a motor module having a double inverter configuration. Similarly to JP 5177711 B, the motor module of Patent JP 2017-191093 A also includes two circuit boards, passive elements such as a smoothing capacitor and a choke coil are mounted on one side, and control circuits such as a microcontroller and a pre-driver are mounted on the other side.

There has been a demand for further size reduction of the motor module in the above-described conventional techniques.

### SUMMARY

Example embodiments of the present disclosure provide motor modules each capable of realizing power supply redundancy and realizing size reduction, and electric power steering devices each including the motor module.

A motor module according to an example embodiment of the present disclosure includes a motor including n-phase windings where n is an integer of three or more, a first circuit board, a first inverter mounted on the first circuit board and connected to the n-phase windings, a first passive element group mounted on the first circuit board, a first heat sink that is in thermal contact with the first circuit board, a second circuit board, a second inverter mounted on the second circuit board and connected to the n-phase windings, and a second passive element group mounted on the second circuit board. A first passive element having a highest height in the first passive element group and a second passive element having a highest height in the second passive element group are located between the first circuit board and the second circuit board, and do not overlap each other when viewed along a direction of a rotation axis of a rotor of the motor.

According to example embodiments of the present disclosure, motor modules are each capable of realizing power supply redundancy and realizing size reduction, and electric power steering devices each including the motor module are provided.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram illustrating a typical block configuration of a motor module 1000 according to an example embodiment of the present disclosure.

FIG. 2 is a circuit diagram illustrating a representative FHB type circuit configuration of a power conversion device 100 according to an example embodiment of the present disclosure.

FIG. 3 is a block diagram illustrating a typical block configuration of a first motor control device 310.

FIG. 4 is a schematic view illustrating a structure of the motor module 1000 according to an example embodiment of the present disclosure.

FIG. 5 is a block diagram illustrating a block configuration of a motor control device according to a first example embodiment of the present disclosure.

FIG. 6 is a block diagram illustrating another block configuration of the motor control device according to the first example embodiment of the present disclosure.

FIG. 7 is a circuit diagram illustrating a circuit configuration example of a step-up circuit.

FIG. 8 is a block diagram illustrating still another block configuration of the motor control device according to the first example embodiment of the present disclosure.

FIG. 9 is a circuit diagram illustrating a circuit configuration example of a step-down circuit.

FIG. 10 is a schematic view illustrating a mounting state of electronic components between a circuit board CB1 and a circuit board CB2 in a cross section of the motor module 1000 when cut along a center axis 211.

FIG. 11 is a schematic view illustrating a mounting state of electronic components between the circuit board CB1 and the circuit board CB2 in the cross section of the motor module 1000 when cut along the center axis 211.

FIG. 12 is a schematic view illustrating a mounting state of electronic components between the circuit board CB1 and the circuit board CB2 in the cross section of the motor module 1000 when cut along the center axis 211.

FIG. 13 is a circuit diagram illustrating a circuit configuration according to a modification of the power conversion device 100 according to the first example embodiment of the present disclosure.

FIG. 14 is a block diagram illustrating a block configuration of a motor control device according to a second example embodiment of the present disclosure.

FIG. 15 is a block diagram illustrating another block configuration of the motor control device according to the second example embodiment of the present disclosure.

FIG. 16 is a schematic view illustrating a mounting state of electronic components between the circuit board CB1 and the circuit board CB2 in the cross section of the motor module 1000 when cut along the center axis 211.

FIG. 17 is a schematic view illustrating a mounting state of electronic components between the circuit board CB1 and the circuit board CB2 in the cross section of the motor module 1000 when cut along the center axis 211.

FIG. 18A is a schematic view illustrating a state where electronic components are mounted on both surfaces of the circuit board CB1.

FIG. 18B is a schematic view illustrating the state where electronic components are mounted on both the surfaces of circuit board CB1.

FIG. 19 is a schematic view illustrating an arrangement state of the circuit board CB1 and the circuit board CB2 in a z-axis direction in the motor module 1000 according to the second example embodiment of the present disclosure.

FIG. 20 is a schematic view illustrating a typical configuration of an electric power steering device 3000 according to a third example embodiment of the present disclosure.

### DETAILED DESCRIPTION

Hereinafter, example embodiments of motor modules, and electric power steering devices of the present disclosure will be described in detail with reference to the accompanying drawings. However, there is a case where a detailed description more than necessary is omitted in order to prevent the following description from being unnecessarily redundant and to facilitate understanding by those skilled in the art. For example, detailed descriptions of already well-known matters and repeated descriptions for substantially the same configuration are omitted in some cases. In addition, one example embodiment can be combined with another example embodiment as long as there occurs no contradiction.

In the present specification, example embodiments of the present disclosure will be described by taking, as an example, a full H-bridge (FHB) type power conversion device that converts power from a power supply into power to be supplied to a three-phase motor having three-phase (A-phase, B-phase, C-phase) windings. However, a power conversion device that converts power from a power supply into power to be supplied to an n-phase motor having n-phase winding (n is an integer of four or more), such as four-phase windings and five-phase windings, is also within the scope of the present disclosure. Further, a power conversion device having a double inverter configuration as disclosed in Patent Literature 1 or 2 is also included in the scope of the present disclosure.

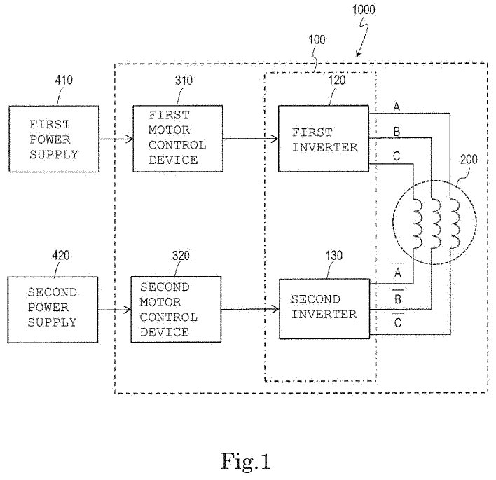

First, a representative block configuration of a motor module 1000 according to the present disclosure will be described with reference to FIG. 1.

FIG. 1 illustrates the representative block configuration of the motor module 1000 according to the present disclosure. The motor module 1000 include as power conversion device 100 having a first inverter 120 and a second inverter 130, a motor 200, a first motor control device 310, and a second motor control device 320. The motor module 1000 is connected to external first power supply 410 and second power supply 420 via a harness. In the present specification, the first motor control device 310 and the second motor control device 320 may be collectively referred to as a “motor control device”.

The motor module 1000 is modularized and can be manufactured and sold as, for example, an electromechanically integrated motor having a motor, a sensor, a driver, and a controller. The motor module 1000 is suitably used for, for example, an electric power steering (EPS) device. The power conversion device 100 and the motor control device other than the motor 200 can also be manufactured and sold in a modular form.

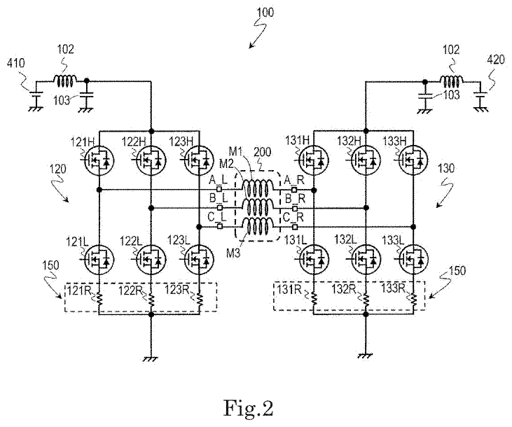

The representative FHB type circuit configuration of the power conversion device 100 of the present disclosure will be described with reference to FIG. 2. However, the power conversion device 100 may have the double inverter structure as described above.

FIG. 2 illustrates the representative FHB type circuit configuration of the power conversion device 100 according to the present disclosure. The power conversion device 100 includes the first inverter 120 and the second inverter 130. The power conversion device 100 converts power from the first power supply 410 and the second power supply 420 into power to be supplied to the motor 200. For example, the first and second inverters 120 and 130 can convert DC power into three-phase AC power that is a pseudo sine wave of an A-phase, a B-phase, and a C-phase.

The motor 200 is, for example, a three-phase AC motor. The motor 200 includes an A-phase winding M1, a B-phase winding M2, and a C-phase winding M3, and is connected to the first inverter 120 and the second inverter 130. Specifically, the first inverter 120 is connected to one end of the winding of each phase of the motor 200, and the second inverter 130 is connected to the other end of the winding of each phase. In the present specification, “connection” between parts (components) mainly means electrical connection.

The first inverter 120 has terminals A_L, B_L, and C_L corresponding to the respective phases. The second inverter 130 has terminals A_R, B_R and C_R corresponding to the respective phases. The terminal A_L of the first inverter 120 is connected to one end of the A-phase winding M1, the terminal B_L is connected to one end of the B-phase winding M2, and the terminal C_L is connected to one end of the C-phase winding M3. Similarly to the first inverter 120, the terminal A_R of the second inverter 130 is connected to the other end of the A-phase winding M1, the terminal B_R is connected to the other end of the B-phase winding M2, and the terminal C_R is connected to the other end of C-phase winding M3.

The power supply includes the first power supply 410 that supplies power to the first inverter 120, and the second power supply 420 that supplies power to the second inverter 130. Each power supply voltage of the first power supply 410 and the second power supply 420 is, for example, 12, 16, 24, or 48 V. As the power supply, for example, a DC power supply is used. However, the power supply may be an AC-DC converter and a DC-DC converter or may be a battery (storage battery). In addition, a single power supply common to the first and second inverters 120 and 130 may be used.

A coil 102 is provided between the first power supply 410 and the first inverter 120. A coil 102 is provided between the second power supply 420 and the second inverter 130. The coil 102 functions as a noise filter, and smoothes high frequency noise included in a voltage waveform supplied to each inverter or high frequency noise generated by each inverter so as not to flow out to the power supply side.

A capacitor 103 is connected to a power supply terminal of each inverter. The capacitor 103 is a so-called bypass capacitor and suppresses a voltage ripple. The capacitor 103 is, for example, an electrolytic capacitor, and the capacitance and the number to be used are appropriately determined according to design specifications and the like.

The first inverter 120 includes a bridge circuit having three legs. Each leg has a low-side switching element and a high-side switching element. An A-phase leg has a low-side switching element 121L and a high-side switching element 121H. A B-phase leg has a low-side switching element 122L and a high-side switching element 122H. A C-phase leg has a low-side switching element 123L and a high-side switching element 123H. As the switching element, for example, a field effect transistor (typically, a MOSFET) or an insulated gate bipolar transistor (IGBT) can be used. Hereinafter, an example in which a MOSFET is used as a switching element will be described, and the switching element is referred to as SW in some cases. For example, the low-side switching elements 121L, 122L, and 123L are referred to as SW 121L, 122L, and 123L, respectively.

The first inverter 120 includes three shunt resistors 121R, 122R, and 123R included in a current sensor 150 configured to detect a current flowing in each phase winding of the A-phase, the B-phase, and the C-phase. The current sensor 150 includes a current detection circuit (not illustrated) that detects a current flowing in each shunt resistor. For example, each of the shunt resistors 121R, 122R, and 123R are connected between each of the three low-side switching elements included in the three legs of the first inverter 120 and the GND. Specifically, the shunt resistor 121R is electrically connected between the SW 121L and the GND, and the shunt resistor 122R is electrically connected between the SW 122L and the GND, and the shunt resistor 123R is electrically connected between the SW 123L and the GND. A resistance value of the shunt resistor is, for example, about 0.5 mΩ to 1.0 mΩ.

The second inverter 130 includes a bridge circuit having three legs, which is similar to the first inverter 120. An A-phase leg has a low-side switching element 131L and a high-side switching element 131H. A B-phase leg has a low-side switching element 132L and a high-side switching element 132H. A C-phase leg has a low-side switching element 133L and a high-side switching element 133H. In addition, the second inverter 130 includes three shunt resistors 131R, 132R, and 133R included in a current sensor 150. Each of these shunt resistors is connected between each of the three low-side switching elements included in the three legs and the GND.

The number of shunt resistors is not limited to three for each inverter. For example, it is possible to use two shunt resistors for the A-phase and the B-phase, two shunt resistors for the B-phase and the C-phase, and two shunt resistors for the A-phase and the C-phase. The number of shunt resistors to be used and the arrangement of the shunt resistors are appropriately determined in consideration of product cost and design specifications.

The number of switching elements to be used is not limited to the illustrated example, and is appropriately determined in consideration of design specifications and the like. Particularly in the in-vehicle field, high quality assurance is required from the viewpoint of safety, and thus, it is preferable to provide a plurality of switching elements used for each inverter.

As described above, the second inverter 130 has substantially the same structure as the structure of the first inverter 120. In FIG. 2, the left inverter on the paper surface is referred to as the first inverter 120, and the right inverter is referred to as the second inverter 130 for convenience of the description. However, such notation should not be construed with the intention of limiting the present disclosure. The terms of the first and second inverters 120 and 130 may be used interchangeably as components of power conversion device 100.

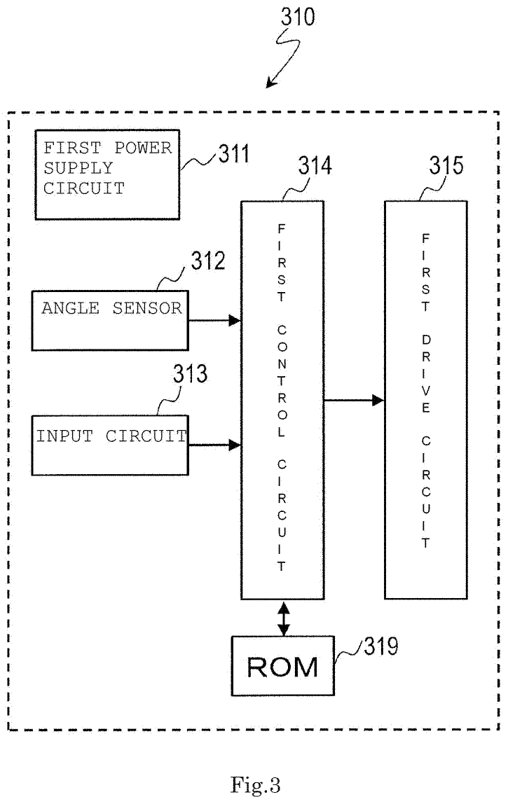

A block configuration around the first control circuit 314 in the first motor control device 310 will be described with reference to FIG. 3. A block configuration of the second motor control device 320 is substantially the same as that of the first motor control device 310 in terms of performing the motor control, and thus, the description thereof will be omitted.

FIG. 3 illustrates a typical block configuration of the first motor control device 310. The first motor control device 310 includes, for example, a first power supply circuit 311, an angle sensor 312, an input circuit 313, a first control circuit 314, a first drive circuit 315, and a ROM 319. The angle sensor 312 is a sensor common to the first motor control device 310 and the second motor control device 320. However, as the angle sensor 312, an angle sensor used for the first motor control device 310 and an angle sensor used for the second motor control device 320 may be separately provided.

The first motor control device 310 is connected to the first inverter 120 of the power conversion device 100. The first motor control device 310 controls a switching operation of a plurality of switching elements in the first inverter 120. Specifically, the first motor control device 310 generates a control signal (hereinafter, referred to as a “gate control signal”) to control the switching operation of each SW, and outputs the control signal to the first inverter 120. The second motor control device 320 is connected to the second inverter 130. The second motor control device 320 generates a gate control signal and outputs the gate control signal to the second inverter 130.

The motor control device can realize closed loop control by controlling a position, a rotational speed, a current, and the like of a rotor of the target motor 200. Note that the motor control device may include a torque sensor instead of the angle sensor 312. In this case, the motor control device can control a target motor torque.

The first power supply circuit 311 generates a DC voltage (for example, 3 V or 5 V) necessary for each block in the circuit. The first power supply circuit 311 is different from a power system power supply circuit to be described later.

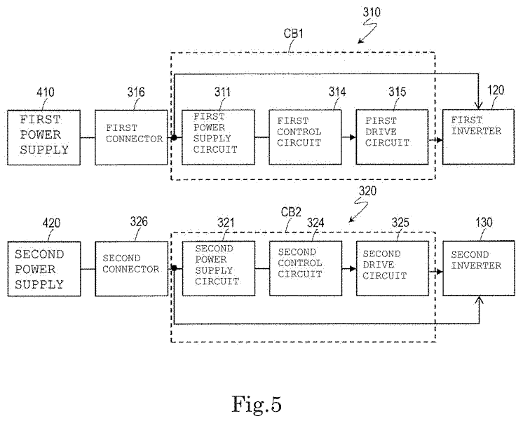

The angle sensor 312 is, for example, a resolver or a Hall IC. Alternatively, the angle sensor 312 is also realized by a combination of an MR sensor having a magnetoresistive (MR) element and a sensor magnet. The angle sensor 312 detects a rotation angle of the rotor (hereinafter, referred to as a “rotation signal”), and outputs the rotation signal to the first control circuit 314 and the second control circuit 324 of the second motor control device 320 (see FIG. 5).

The input circuit 313 receives a motor current value (hereinafter, referred to as an “actual current value”) detected by the shunt resistors 121R, 122R, and 123R of the current sensor 150, converts a level of the actual current value into an input level of the first control circuit 314 as necessary, and outputs the actual current value to the first control circuit 314. The input circuit 313 is, for example, an analog/digital conversion circuit.

The first control circuit 314 is an integrated circuit that controls the first inverter 120, and is, for example, a microcontroller or a field programmable gate array (FPGA).

The first control circuit 314 controls the switching operation (turn-on or turn-off) of each SW in the first inverter 120 of the power conversion device 100. The first control circuit 314 sets a target current value according to the actual current value, the rotation signal of the rotor, and the like, generates a PWM signal, and outputs the PWM signal to the first drive circuit 315.

The first drive circuit 315 is typically a gate driver (or pre-driver). The first drive circuit 315 generates a gate control signal according to the PWM signal, and supplies the gate control signal to a gate of the switching element in the first inverter 120. There is a case where a gate driver is not necessarily required when a driving target is a motor that can be driven at a low voltage. In such a case, the function of the gate driver may be implemented in the first control circuit 314.

The ROM 319 is electrically connected to the first control circuit 314. The ROM 319 is, for example, a writable memory (for example, a PROM), a rewritable memory (for example, a flash memory), or a read-only memory. The ROM 319 stores a control program including a command group configured to cause the first control circuit 314 to control the power conversion device 100. For example, the control program is temporarily expanded in a RAM (not illustrated) at the time of booting.

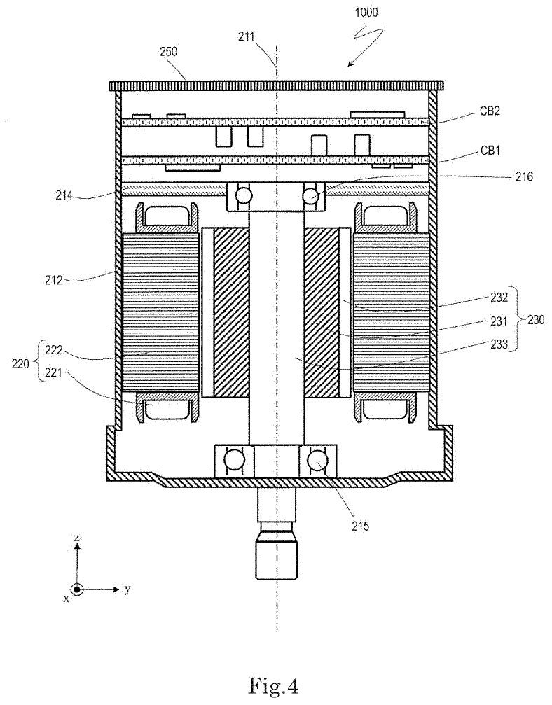

FIG. 4 is a schematic view illustrating a structure of the motor module 1000. FIG. 4 illustrates a cross section of the motor module 1000 when a yz plane in the drawing is cut along a center axis 211.

The motor module 1000 includes a stator 220, a rotor 230, a housing 212, a bearing holder 214, a bearing 215, and a bearing 216. The stator 220 is also called an armature. The center axis 211 is a rotation axis of the rotor 230.

The housing 212 is a substantially cylindrical casing having a bottom, and houses the stator 220, the bearing 215, and the rotor 230 therein.

The bearing holder 214 separates a space in which the stator 220 and the rotor 230 are housed inside the motor module 1000 and a space in which two circuit boards (first and second circuit boards) CB1 and CB2 are housed. The bearing holder 214 is a plate-shaped member, and holds the bearing 216 at the center thereof.

The stator 220 is annular, and includes a stacked body 222 and a winding 221. The stacked body 222 is also called a stacked annular core. The winding is also called a coil. The stator 220 generates a magnetic flux in response to a drive current. The stacked body 222 is configured using a stacked steel sheet in which a plurality of steel sheets are stacked in a direction along the center axis 211 (the z direction in FIG. 4). The stacked body 222 is fixed to an inner wall of the housing 212.

The winding 221 is made of a conductive material such as copper, and is typically attached to a plurality of teeth (not illustrated) of the stacked body 222.

The rotor 230 includes a rotor core 231, a plurality of permanent magnets 232 provided along an outer periphery of the rotor core 231, and a shaft 233. The rotor core 231 is made of a magnetic material such as iron, for example, and has a tubular shape. In the present example embodiment, the rotor core 231 is configured using a stacked steel plate in which a plurality of steel plates are stacked in the direction along the center axis 211 (the z direction in FIG. 4). The plurality of permanent magnets 232 are provided such that N poles and S poles alternately appear in the circumferential direction of the rotor core 231. The shaft 233 is fixed to the center of the rotor core 231 and extends in the up-down direction (the z direction) along the center axis 211. Note that the up, down, left, and right directions in the present specification are the up, down, left, and right directions when the motor module 1000 illustrated in FIG. 4 is viewed, and the example embodiments are described using those directions for easy understanding. It is a matter of course that the up, down, left, and right directions in the present specification do not always coincide with the up, down, left, and right directions when the motor module 1000 is mounted on an actual product (such as an automobile).

The bearings 215 and 216 rotatably support the shaft 233 of the rotor 230. The bearings 215 and 216 are, for example, ball bearings that relatively rotate an outer ring and an inner ring via a sphere.

When a drive current flows through the winding 221 of the stator 220 in the motor module 1000, a radial magnetic flux is generated in the plurality of teeth of the stacked body 222. A torque is generated in the circumferential direction by the action of the magnetic flux between the plurality of teeth and the permanent magnet 232, and the rotor 230 rotates with respect to the stator 220. When the rotor 230 rotates, a driving force is generated in the EPS device, for example.

For example, a permanent magnet (not illustrated) is fixed to an end of the shaft 233 on the bearing holder 214 side. The permanent magnet is rotatable together with the rotor 230. A magnetic sensor (not illustrated) corresponding to the angle sensor 312 is arranged, for example, on the circuit board CB1 at a position opposing the permanent magnet fixed to the shaft 233. The magnetic sensor may be mounted on another circuit board different from the circuit board CB1 or the circuit board CB2. The magnetic sensor detects a magnetic field generated from the permanent magnet that rotates together with the shaft 233, and as a result, can detect a rotation angle of the rotor 230.

The two circuit boards are arranged above the bearing holder 214. On the circuit board CB1, the coil 102 for the first inverter 120, the capacitor 103, the first inverter 120, electronic components of the first motor control device 310, and the like are mounted. On the circuit board CB2, the coil 102 for the second inverter 130, the capacitor 103, the second inverter 130, electronic components of the second motor control device 320, and the like are mounted. A component group of the motor module 1000 can be mounted on one surface or both surfaces of each circuit board. An upper opening of the housing 212 is closed by a cover 250.

### First Example Embodiment

In the present example embodiment, power supply voltages of the first power supply 410 and the second power supply 420 are the same, and a description will be given on the assumption that those power supply voltages are 12 V.

FIG. 5 illustrates a block configuration of the motor control device according to the present example embodiment. The first motor control device 310 includes the first power supply circuit 311, the first control circuit 314, and the first drive circuit 315. The first power supply circuit 311, the first control circuit 314, and the first drive circuit 315 are mounted on the circuit board CB1. A first connector 316 is a separate component from the circuit board CB1. The circuit board CB1 is connected to the first power supply 410 via the first connector 316.

The power supply voltage of 12 V is supplied from the first power supply 410 to the first inverter 120. The first power supply circuit 311 generates a DC voltage (for example, 3 V) required for the first control circuit 314 and the first drive circuit 315 by stepping down the power supply voltage of 12 V of the first power supply 410. The first control circuit 314 outputs a PWM signal to the first drive circuit 315. The first drive circuit 315 generates a gate control signal according to the PWM signal and supplies the gate control signal to each switching element of the first inverter 120.

The second motor control device 320 includes the second power supply circuit 321, the second control circuit 324, and a second drive circuit 325. The second power supply circuit 321, the second control circuit 324, and the second drive circuit 325 are mounted on the circuit board CB2. A second connector 326 is a separate component from the circuit board CB2. The circuit board CB2 is connected to the second power supply 420 via the second connector 326.

The power supply voltage of 12 V is supplied from the second power supply 420 to the second inverter 130. The second power supply circuit 321 generates a DC voltage (for example, 3 V) required for the second control circuit 324, the second drive circuit 325, and the like by stepping down the power supply voltage of 12 V of the second power supply 420. The second control circuit 324 outputs a PWM signal to the second drive circuit 325. The second drive circuit 325 generates a gate control signal according to the PWM signal and supplies the gate control signal to each switching element of the second inverter 130.

The connection between the first power supply 410 and the first connector 316 and the connection between the second power supply 420 and the second connector 326 are generally performed using a harness (not illustrated). A power loss (or voltage drop) due to the harness occurs in a current path from the power supply to the motor. For example, a resistance value of the harness used in the EPS system is about 15 to 20 mΩ. This value is greater than a resistance value of the motor or ECU and the power loss thereof is not ignorable. For example, if the power supply current is 100 A at the maximum, the voltage drop in the harness is about 1.5 to 2.0 V, which is not ignorable for the power supply of 12 V. Therefore, a higher output of the motor is expected if the power loss of the harness can be improved.

Since two systems of the first power supply 410 and the second power supply 420 are used in the present example embodiment, it is possible to supply a necessary current to the motor 200 from two harnesses. Here, it is considered a case where a current, which is the same as the current to be supplied to the motor, is supplied using two systems of power supplies when supplying power to two circuit boards using a single power supply. In this case, it is sufficient to cause half the current to flow through each of the harnesses, so that a diameter of the harness can be reduced. As a result, the power loss in the harness can be reduced to about ¼.

In consideration of TN characteristics of the motor, it is difficult to obtain a sufficient output (or torque) during high-speed rotation of the motor when using the single power supply. According to the present example embodiment, however, the efficiency indicating a ratio of output power relative to input power can be improved since the power loss in the harness is reduced, and thus, it is possible to obtain a high output during the high-speed rotation of the motor.

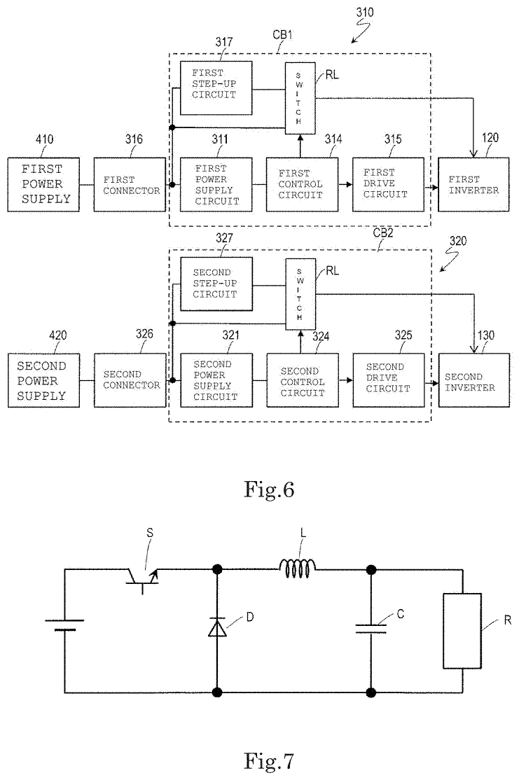

FIG. 6 illustrates another block configuration of the motor control device according to the present example embodiment. FIG. 7 illustrates a circuit configuration example of a step-up circuit.

A switch RL and a first step-up circuit 317 may be further mounted on the circuit board CB1, and a switch RL and a second step-up circuit 327 may be further mounted on the circuit board CB2.

Each of the first step-up circuit 317 and the second step-up circuit 327 is, for example, a step-up chopper circuit. FIG. 7 illustrates a representative circuit configuration of the step-up chopper circuit. The step-up chopper circuit includes a semiconductor switch S, a diode D, a capacitor C, a coil L, and the like.

The first step-up circuit 317 can step up the power supply voltage of 12 V of the first power supply 410 and output a step-up voltage (for example, 24 V) to the first inverter 120. The second step-up circuit 327 can step up the power supply voltage of 12 V of the second power supply 420 and output a step-up voltage (for example, 24 V) to the second inverter 130. The step-up chopper circuit is appropriately determined according to the power supply connected to each circuit board.

The switch RL is, for example, a thyristor, an analog switch IC, or a semiconductor switch such as a MOSFET in which a parasitic diode is formed, or a mechanical relay. For example, the switch RL of the circuit board CB1 switches a power supply path of the first inverter 120 under the control of the first control circuit 314. For example, the switch RL of the circuit board CB2 switches a power supply path of the second inverter 130 under the control of the second control circuit 324.

For example, during normal driving, a power supply path for supplying 12 V from the first power supply 410 to the first inverter 120 is selected by the switch RL, and a power supply path for supplying 12 V from the second power supply 420 to the second inverter 130 is selected by the switch RL. During the high-speed rotation, a power supply path for supplying the step-up voltage of 24 V from the first step-up circuit 317 to the first inverter 120 is selected by the switch RL, and a power supply path for supplying the step-up voltage of 24 V from the second step-up circuit 327 to the second inverter 130 is selected by the switch RL. According to such a configuration, a high voltage can be supplied to each of the inverters by dynamically switching the switch RL during the high-speed rotation in the motor driving, and thus, a high output can be obtained during the high-speed rotation.

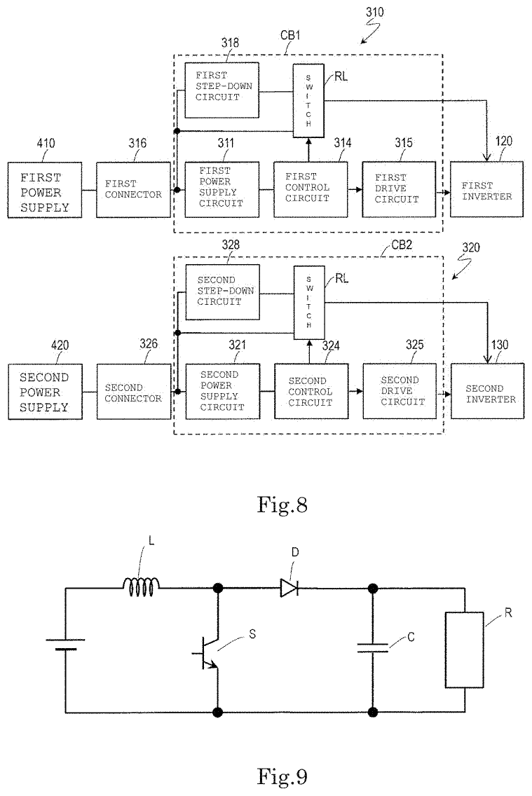

FIG. 8 illustrates still another block configuration of the motor control device according to the present example embodiment. FIG. 9 illustrates a circuit configuration example of a step-down circuit.

The power supply voltages of the first power supply 410 and the second power supply 420 are not limited to 12 V, and may be, for example, 24 V or 48 V. A switch RL and a first step-down circuit 318 may be further mounted on the circuit board CB1, and a switch RL and a second step-down circuit 328 may be further mounted on the circuit board CB2.

Each of the first step-down circuit 318 and the second step-down circuit 328 is, for example, a step-down chopper circuit. FIG. 9 illustrates a representative circuit configuration of the step-down chopper circuit. The step-down chopper circuit includes a semiconductor switch S, a diode D, a capacitor C, a coil L, and the like.

For example, the first step-down circuit 318 can step down the power supply voltage of 24 V of the first power supply 410 and output a step-down voltage of 12 V to the first inverter 120. The second step-down circuit 328 can step down the power supply voltage of 24 V of the second power supply 420 and output the step-down voltage of 12 V to the second inverter 130. The step-down chopper circuit is appropriately determined according to the power supply connected to each circuit board.

For example, during the normal driving, a power supply path for supplying the step-down voltage of 12 V from the first step-down circuit 318 to the first inverter 120 is selected by the switch RL, and a power supply path for supplying the step-down voltage of 12 V from the second step-down circuit 328 to the second inverter 130 is selected by the switch RL. During the high-speed rotation, a power supply path for supplying 24 V from the first power supply 410 to the first inverter 120 is selected by the switch RL, and a power supply path for supplying 24 V from the second power supply 420 to the second inverter 130 is selected by the switch RL. According to such a configuration, a high voltage can be supplied to each of the inverters by dynamically switching the switch RL during the high-speed rotation in the motor driving, and thus, a high output can be obtained during the high-speed rotation.

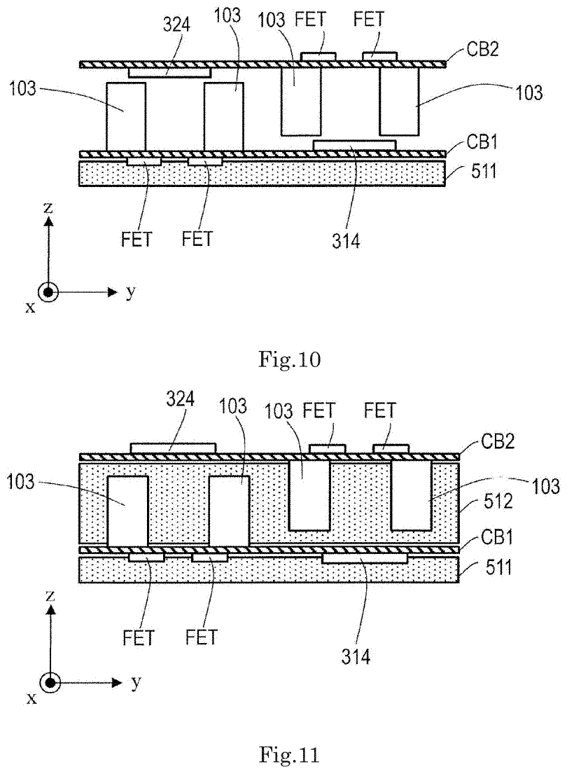

FIGS. 10 to 12 illustrate mounting states of electronic components between the circuit board CB1 and the circuit board CB2 in a cross section of the motor module 1000 when cut along the center axis 211.

In one aspect, a first passive element group such as the capacitor 103 and the coil 102 (not illustrated in FIG. 10) is mounted on the circuit board CB1 as illustrated in FIG. 10. The first motor control device 310 that controls the switching operation of the plurality of switching elements in the first inverter 120 is further mounted on a surface of the circuit board CB1 on which the capacitor 103 is mounted. On a surface of the circuit board CB1 opposite to the surface on which the capacitor 103 is mounted, a first power device group constituting the first inverter 120 is mounted. FIG. 10 illustrates the first control circuit 314 among the components of the first motor control device 310, and illustrates two power devices (FETs) among the components of the first power device group. The power device is the switching element SW of the inverter. It is a matter of course that the present invention is not limited to the illustrated example, and the components of the first power device group and the capacitor 103 can be arranged at positions that do not overlap each other when the circuit board is seen through from the direction of the center axis 211.

On the circuit board CB2, a second passive element group such as the capacitor 103 and the coil 102 (not illustrated in FIG. 10) is mounted. The second motor control device 320 that controls the switching operation of the plurality of switching elements in the second inverter is further mounted on a surface of the circuit board CB2 on which the capacitor 103 is mounted. On the surface of the circuit board CB2 opposite to the surface on which the capacitor 103 is mounted, a second power device group constituting the second inverter 130 is mounted. FIG. 10 illustrates the first control circuit 314 among the components of the second motor control device 320, and illustrates two power devices among the components of the second power device group.

The capacitor 103 in the first passive element group and the capacitor 103 in the second passive element group are arranged between the circuit board CB1 and the circuit board CB2, and do not overlap each other when viewed along the center axis 211 (the z direction in FIG. 10). Since the power supply voltages of the first power supply 410 and the second power supply 420 are equal in the present example embodiment, the same capacitor can be used as the capacitor 103 mounted on the circuit board CB1 and the capacitor 103 mounted on the circuit board CB2. In such a case, the capacitors 103 of both the circuit boards have the same height.

The motor module 1000 can further include a first heat sink 511 that is in thermal contact with the circuit board CB1 via a heat dissipating material having insulation properties, for example, heat dissipating grease. The first heat sink 511 covers the first power device group on the circuit board CB1. In the present specification, the “thermal contact with the circuit board” means a state where the heat sink covers all or some of a plurality of electronic components mounted on one surface of a circuit board. The heat sink is not necessarily in contact with the surface of the circuit board.

As the first heat sink 511, for example, a material having good thermal conductivity such as aluminum can be used. For example, the first heat sink 511 can be a holder of the housing 212 or the bearing holder 214. Alternatively, the first heat sink 511 may be a member different from these members. As the circuit board CB1 is cooled by the first heat sink 511, heat dissipating properties of the motor module 1000 can be improved.

In one aspect, the motor module 1000 further includes a second heat sink 512 that is arranged between the circuit board CB1 and the circuit board CB2 and is in thermal contact with both the circuit boards, for example, via heat dissipating grease as illustrated in FIG. 11. The second heat sink 512 has a concave portion that covers the capacitor 103. As the second heat sink 512 covers a capacitor that particularly generates heat among the mounted components, heat can be efficiently dissipated. As the circuit board CB1 and the circuit board CB2 are cooled using the second heat sink 512 in this manner, the heat dissipating properties of the motor module 1000 can be further improved.

In one aspect, the first motor control device 310 is mounted on the surface of the circuit board CB1 opposite to the surface on which the capacitor 103 is mounted, and the second motor control device 320 is mounted on the surface of the circuit board CB2 opposite to the surface on which the capacitor 103 is mounted, as illustrated in FIG. 11. FIG. 11 illustrates the first control circuit 314 among the components of the first motor control device 310, and illustrates the second control circuit 324 among the components of the second motor control device 320.

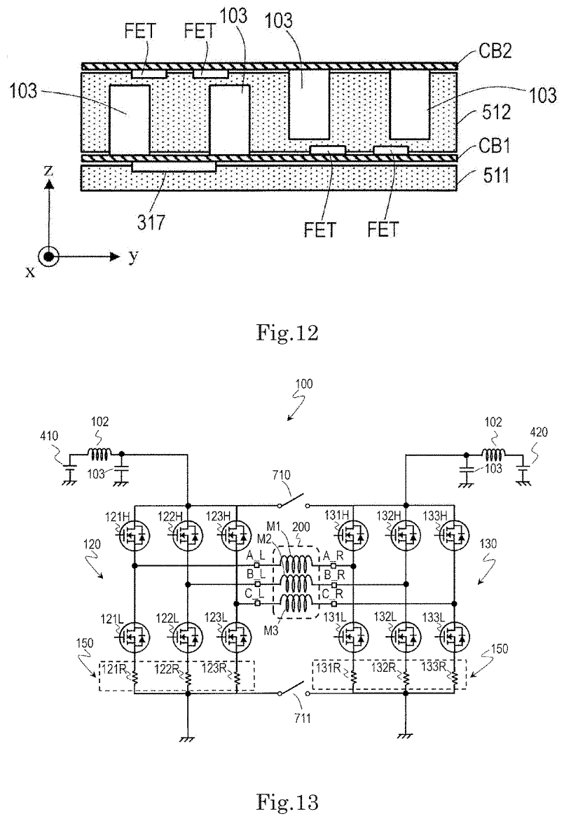

In one aspect, the first power device group constituting the first inverter 120 is further mounted on the surface of the circuit board CB1 on which the capacitor 103 is mounted, and the second power device group constituting the second inverter 130 is further mounted on the surface of the circuit board CB2 on which the capacitor 103 is mounted, as illustrated in FIG. 12. For example, the first step-up circuit 317 or the first step-down circuit 318 can be mounted on the surface of the circuit board CB1 opposite to the surface on which the capacitor 103 is mounted. In such a case, the first heat sink 511 has a concave portion that covers the first step-up circuit 317 or the first step-down circuit 318. As the first step-up circuit 317 or the first step-down circuit 318, which generates a large amount of heat, is covered and cooled with the first heat sink 511, the heat dissipating properties of the motor module 1000 can be improved.

FIG. 13 illustrates a circuit configuration according to a modification of the power conversion device 100 of the present example embodiment. In this modification, the power conversion device 100 further includes two switching elements 710 and 711. The switching element 710 switches connection/disconnection between a node on a high side of a bridge circuit of the first inverter 120 and a node on a high side of a bridge circuit of the second inverter 130. The switching element 711 switches connection/disconnection between a node on a low side of the bridge circuit of the first inverter 120 and a node on a low side of the bridge circuit of the second inverter 130. The two switching elements 710 and 711 are, for example, thyristors, analog switch ICs, or semiconductor switches such as a MOSFET in which a parasitic diode is formed, or mechanical relays.

According to this configuration, a zero-phase current can flow, and, for example, two-phase energization control can be performed. For example, when the A-phase leg fails, the two-phase windings M2 and M3 can be energized using the B-phase and C-phase. For example, the two-phase energization control is described in WO 2017/150638 which is a patent application filed by the present applicant. The entire content of the disclosure is incorporated herein by reference. Further, when one of the first power supply 410 and the second power supply 420 fails, three-phase energization control of energizing the three-phase windings using the other can be continued.

For example, the connection of the motor can be switched to the Y connection using the first drive circuit 315 or the second drive circuit 325. During the normal driving, the motor connection is, for example, the FHB connection illustrated in FIG. 2 or FIG. 13. After the connection of the motor 200 is switched from the FHB connection to the Y connection, it is preferable to drive the Y-connected motor 200 using a power supply voltage that is twice a power supply voltage used in the FHB connection. For example, a power supply voltage of 12 V is used for driving in the FHB connection, and a power supply voltage of 24 V is used for driving in the Y connection. As a result, even when the connection of the motor 200 is switched from the FHB connection to the Y connection, the maximum rotation speed of the motor 200 can be maintained.

For example, when the high-side switching element 121H of the first inverter 120 has an open failure, the connection of the motor can be switched to the Y connection. The first drive circuit 315 outputs a control signal to constantly turn off the remaining high-side switching elements 122H and 123H and constantly turn on the three low-side switching elements 121L, 122L, and 123L. As a result, a neutral point is formed in the first inverter 120. In this state, the second motor control device 320 can perform PWM control on the switching element of the second inverter 130. The second power supply 420 may be used for switching to the Y connection, or another power supply different from the first power supply 410 or the second power supply 420 may be used.

When the power supply voltages of the first power supply 410 and the second power supply 420 are equal as in the present example embodiment, the zero-phase current does not flow in each phase in the FHB connection. For this reason, when an 8 pole 12 slot (8P12S) motor, for example, having a large mutual inductance is connected to the FHB power conversion device 100 and driven, it is possible to suppress current noise caused by switching of the switching elements of the first and second inverters 120 and 130.

### Second Example Embodiment

The present example embodiment is different from the first example embodiment in terms that a power supply voltage of the first power supply 410 is different from a power supply voltage of the second power supply 420. Hereinafter, differences from the first example embodiment will be mainly described.

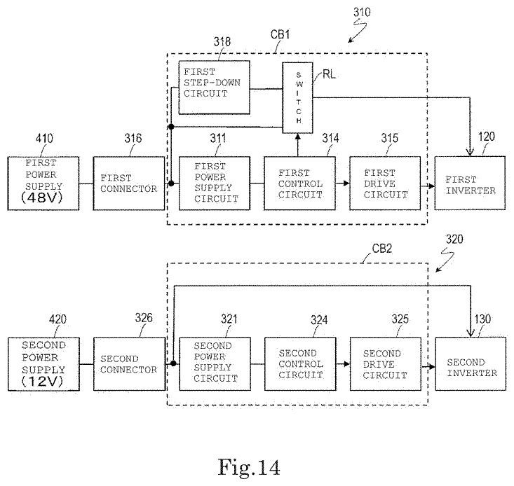

FIG. 14 illustrates a block configuration of a motor control device according to the present example embodiment. The power supply voltage of the first power supply 410 is higher than the power supply voltage of the second power supply 420. For example, the power supply voltage of the first power supply 410 is 48 V, and the power supply voltage of the second power supply 420 is 12 V. A power system power supply circuit that steps down or steps up the power supply voltage of the first power supply 410 is mounted on the circuit board CB1. FIG. 14 illustrates the first step-down circuit 318 serving as the power system power supply circuit. For example, the first step-down circuit 318 steps down the power supply voltage of 48 V of the first power supply 410, and outputs a step-down voltage of 12 V to the first inverter 120 via the switch RL.

According to this configuration, when performing three-phase conduction control of FHB, the step-down voltage of 12 V output from the first step-down circuit 318 is supplied to the first inverter 120, and the power supply voltage of 12 V of the second power supply 420 is supplied to the second inverter 130. For example, when the motor connection on the second inverter 130 side is switched to the Y connection using the second drive circuit 325 as described above, the switching element of the first inverter 120 can be PWM-controlled with the power supply voltage of 48 V of the first power supply.

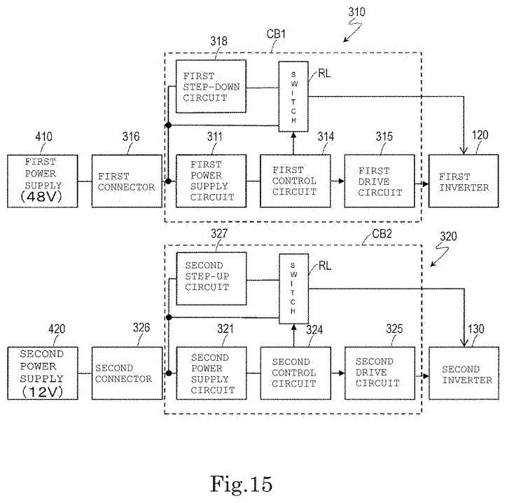

FIG. 15 illustrates another block configuration of the motor control device according to the present example embodiment. For example, the second step-up circuit 327 that steps up the power supply voltage of 12 V of the second power supply 420 and outputs a step-up voltage of 24 V to the second inverter 130 may be further mounted on the circuit board CB2. The first step-down circuit 318 can generate a step-down voltage of 24 V or 12 V.

According to this configuration example, it is possible to perform the three-phase conduction control of FHB at 12 V during normal driving, for example, by supplying the step-down voltage of 12 V from the first step-down circuit 318 to the first inverter 120 and supplying the power supply voltage of 12 V of the second power supply to the second inverter 130. On the other hand, it is possible to control the three-phase conduction of FHB at 24 V during high-speed rotation, for example, by supplying the step-down voltage of 24 V from the first step-down circuit 318 to the first inverter 120 and supplying the step-up voltage 24 V from the second step-up circuit 327 to the second inverter 130. A high voltage can be supplied to each of the inverters by dynamically switching the switch RL during the high-speed rotation in the motor driving, and thus, a high output can be obtained during the high-speed rotation.

For example, it is considered a case where the motor module 1000 is mounted on EPS. In such a case, for example, even if the first power supply 410 fails, a steering force can be maintained by switching the power supply to the second power supply 420 and using the step-up voltage of the second step-up circuit 327 of the circuit board CB2.

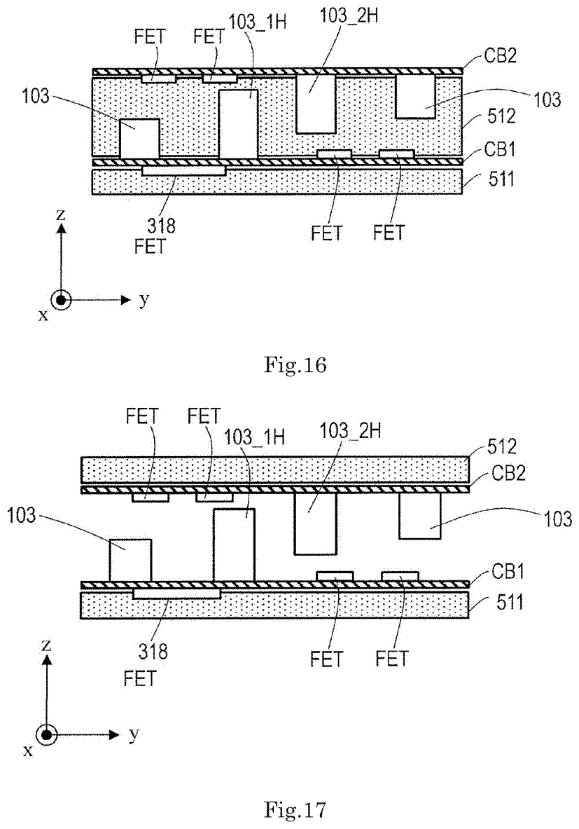

FIGS. 16 and 17 illustrate mounting states of electronic components between the circuit board CB1 and the circuit board CB2 in a cross section of the motor module 1000 when cut along the center axis 211.

A first passive element group is mounted on the circuit board CB1, and a second passive element group is mounted on the circuit board CB2. The highest element in the passive element group including a coil, a resistor, a capacitor, and the like is typically a capacitor. In the present example embodiment, a first passive element having the highest height on the circuit board CB1 is a capacitor 103_1H, and a second passive element having the highest height on the circuit board CB2 is a capacitor 103_2H. In general, a capacitor having a larger capacity is required as the capacitor 103 as the power supply voltage increases. As a result, the capacitor 103 mounted on the circuit board CB1 requires a larger capacity than the capacitor 103 mounted on the circuit board CB2. Therefore, a size of the capacitor 103_1H is larger than that of the capacitor 103_2H, and specifically, the height of the capacitor 103_1H is higher than that of the capacitor 103_2H.

In the present example embodiment, the highest capacitor 103_1H in the first passive element group and the highest capacitor 103_2H in the second passive element group are arranged between the circuit boards CB1 and CB2, and do not overlap each other when viewed along a direction of the center axis 211. As a result, the height of the motor module 1000 can be suppressed, and the motor module having the low height can be realized since the two capacitors 103_1H and 103_2H do not overlap in the direction of the center axis 211. It is assumed that the height of the capacitor 103_1H is h1, and the height of the capacitor 103_2H is h2 (≤h1). If the two capacitors are stacked in the direction of the center axis 211 in the conventional manner, the sum of the heights is h1+h2. On the other hand, if the two capacitors are arranged as illustrated in FIG. 16, two capacitors can be arranged in the range of the height h1.

The motor module 1000 can further include the first heat sink 511 that is in thermal contact with the circuit board CB1 via, for example, heat dissipating grease. For example, the first heat sink 511 can be a holder of the housing 212 or the bearing holder 214. Alternatively, the first heat sink 511 may be a member different from these members.

For example, the first step-down circuit 318 may be mounted on a surface of the circuit board CB1 opposite to a surface on which the capacitor 103_1H is mounted. The rotor 230, the first heat sink 511, the circuit board CB1, and the circuit board CB2 are arranged in this order along the rotation axis of the rotor 230 of the motor 200, that is, the direction of the center axis 211. In particular, the first step-down circuit 318, which is the power system power supply circuit, generates a large amount of heat. As the first step-down circuit 318 is covered with the first heat sink 511, the first step-down circuit 318 can be cooled, and heat dissipating properties of the motor module 1000 can be improved.

In one aspect, the motor module 1000 further includes the second heat sink 512 that is arranged between the circuit board CB1 and the circuit board CB2 and is in thermal contact with both the circuit boards, for example, via heat dissipating grease as illustrated in FIG. 16. According to this configuration, the heat dissipating properties of the motor module 1000 can be further improved by cooling the circuit board CB1 and the circuit board CB2 with the second heat sink 512.

In one aspect, the motor module 1000 further includes the second heat sink 512 that covers the surface of the circuit board CB2 opposite to the surface on which capacitor 103_2H is mounted as illustrated in FIG. 17. The rotor 230, the first heat sink 511, the circuit board CB1, the circuit board CB2, and the second heat sink 512 are arranged in this order along the rotation axis of the rotor 230 of the motor 200, that is, the direction of the center axis 211. According to the above arrangement, the second heat sink 512 is located on the cover 250 side of the motor module 1000, and thus, can be easily exposed to the outside, so that the heat dissipating properties of the motor module 1000 can be improved. Further, a third heat sink may be provided between the circuit board CB1 and the circuit board CB2 as illustrated in FIG. 16.

A heat resistance of the first heat sink 511 is preferably smaller than a heat resistance of the second heat sink 512. For example, the first heat sink 511 has a larger volume than the second heat sink 512.

The cover 250 of the motor module 1000 can function as the second heat sink 512. Alternatively, the second heat sink 512 may be a separate member different from the cover 250. A size of the second heat sink 512 can be made smaller than that of the first heat sink 511, and the number of components of the motor module 1000 can be reduced.

In one aspect, a power supply voltage of the first power supply 410 may be lower than a power supply voltage of the second power supply 420. For example, the power supply voltage of the first power supply 410 may be 12 V, and the power supply voltage of the second power supply 420 may be 48 V. In such a case, the first step-up circuit 317, which is the power system power supply circuit, may be mounted on the circuit board CB1. For example, the first step-up circuit 317 steps up the power supply voltage of 12 V of the first power supply and outputs a step-up voltage of 24 V to the first inverter 120 via the switch RL. In this configuration, the heat generated from the first step-up circuit 317, which is a power system power supply circuit, is particularly large. As the first step-up circuit 317 is covered with the first heat sink 511, the first step-up circuit 317 can be cooled, and the heat dissipating properties of the motor module 1000 can be improved. Further, for example, the second step-down circuit 328 that steps down the power supply voltage of 48 V of the second power supply 420 and outputs a step-down voltage of 24 V to the second inverter 130 via the switch RL may be mounted on the circuit board CB2.

In one aspect, a shape of the circuit board CB1 viewed from the direction of the center axis 211 is the same as a shape of the circuit board CB2, and the circuit board CB1 and the circuit board CB2 have a common symmetry axis AS. The shape of the circuit board is, for example, circular, elliptical, or polygonal. The same circuit board can be used as the circuit board CB1 and the circuit board CB2. Hereinafter, an example of mounting electronic components on the circuit board CB1 between the two circuit boards will be described.

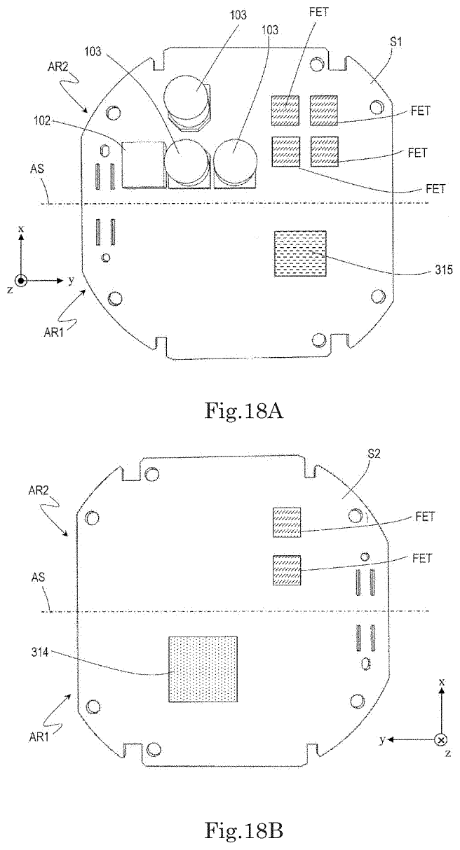

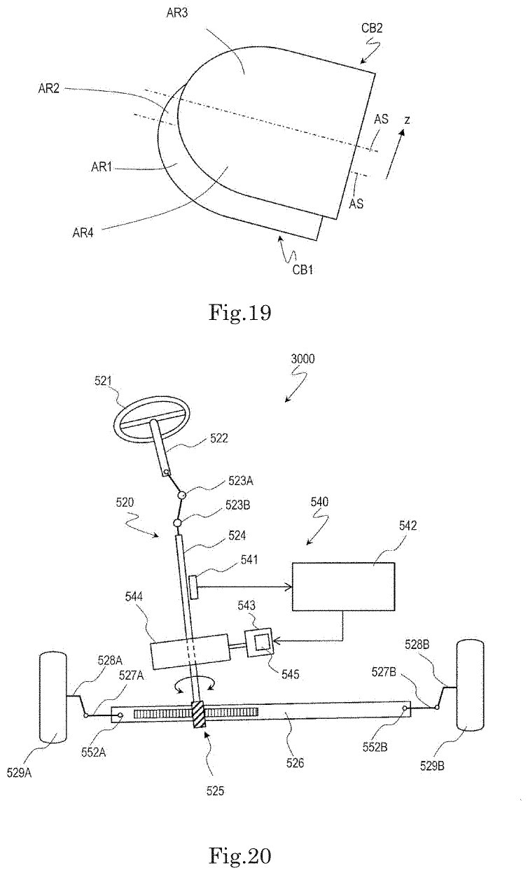

FIGS. 18A and 18B illustrate states where the electronic components are mounted on both surfaces of the circuit board CB1. FIG. 19 illustrates an arrangement state of the circuit board CB1 and the circuit board CB2 in the z-axis direction in the motor module 1000. FIG. 18A illustrates a mounting surface S1 of the circuit board CB1 on which the capacitor 103 is mounted when viewed from a +z direction along the rotation axis of the rotor 230, that is, the center axis 211. FIG. 18B illustrates a mounting surface S2 of the circuit board CB1 opposite to the mounting surface S1 when viewed from a −z direction along the direction of the center axis 211. However, only the main electronic components that can be mounted on both the surfaces are illustrated in order to prevent the drawings from being complicated.

The circuit board CB1 has the symmetry axis AS, and has line symmetry about this axis. The circuit board CB1 includes a first area AR1 where the first motor control device 310 is arranged (a lower area on the paper surface), and a second area AR2 (an upper area on the paper surface) in which the first passive element group and the first power device group are arranged. For example, the first drive circuit 315 of the first motor control device 310 is arranged in the first area AR1 of the mounting surface S1, and four FETs out of six FETs constituting the capacitor 103 and the first inverter 120 are arranged in the second area AR2. For example, the first control circuit 314 of the first motor control device 310 is arranged in the first area AR1 of the mounting surface S2, and the remaining two FETs are arranged in the second area AR2.

The circuit board CB2 has the symmetry axis AS and has line symmetry about this axis. Similarly to the circuit board CB1, a third area AR3 of the circuit board CB2 is an area where the second motor control device 320 is mounted, and a fourth area AR4 of the circuit board CB2 is an area where the second passive element group and the second power device group are mounted. As illustrated in FIG. 19, the circuit board CB2 is arranged on the motor module 1000 by inverting the circuit board CB1 by 180° with respect to the symmetry axis AS. As a result, when the motor module 1000 is viewed along the direction of the center axis 211 (the z-axis in FIG. 19), the first area AR1 and the fourth area AR4 of the circuit board CB2 overlap each other, and the second area AR2 and the third area AR3 of the circuit board CB2 overlap each other.

According to such a configuration, heat dissipating paths of the circuit boards CB1 and CB2 do not overlap each other in the direction of the center axis 211, and thus, it is possible to efficiently dissipate heat from each of the circuit boards. In addition, when the circuit board CB1 and the circuit board CB2 are arranged in the direction of the center axis 211, the respective elements can be arranged symmetrically with respect to the symmetry axis AS. Since the circuit board CB1 and the circuit board CB2 have the same element arrangement, it is sufficient to overlap the circuit board CB1 on the circuit board CB2 during assembly. As the same board design is adopted for the circuit board CB1 and the circuit board CB2 in this manner, the number of design steps can be reduced. Further, since the two capacitors 103_1H and 103_2H do not overlap in the direction of the center axis 211 as described above, the height of the motor module 1000 can be suppressed, and the motor module having the low height can be realized. Further, since the second heat sink 512 is arranged between the circuit board CB1 and the circuit board CB2, the heat can be effectively dissipated from each of the circuit boards.

According to the present disclosure, even if at least one of the switching elements in the power supply system and the power conversion device 100 fails, the motor output can be maintained, and the motor drive can be continued.

### Other Modifications

The configuration or arrangement of the circuit board of the motor module 1000 described in the present specification can be suitably used for a motor module having a double inverter configuration. In the double inverter configuration, the three-phase windings M1, M2, and M3 have a first coil set and a second coil set whose one ends are Y-connected. The first inverter 120 is connected to the first coil set, and the second inverter 130 is connected to the second coil set.

Although the motor module 1000 connected to the two systems of power supplies has been described in the present specification, one system of single power supply may be used. For example, a power supply voltage of 12 V is supplied to the circuit boards CB1 and CB2 from the single power supply at normal time. When the power supply fails, for example, both circuit boards may be connected to another power supply for backup, and power supply of 12 V may be supplied from the power supply to both the circuit boards. Such a power supply system is also included in the scope of the present disclosure. According to this configuration, the motor drive with the FHB connection can be continued.

The motor module 1000 may include a voltage dividing circuit (not illustrated) that connects the circuit board CB1 and the circuit board CB2. According to this configuration, even if one of the two power supplies fails, the other can be used to continue driving the motor. In this manner, one power supply can be branched to the other power supply.

Although the example embodiments using the two circuit boards have been described in the present specification, three or more circuit boards can be used. For example, four circuit boards including (1) the circuit board CB1 on which the first motor control device 310 is arranged and the circuit board CB2 on which the first passive element group and the first power device group are arranged, the circuit board CB1 and the circuit board CB2 being connected to the first power supply 410 and (2) a third circuit board on which the second motor control device 320 is arranged and a fourth circuit board on which the second passive element group and the second power device group are arranged, the third circuit board and the fourth circuit board being connected to the second power supply 420.

### Third Example Embodiment

FIG. 20 schematically illustrates a typical configuration of an electric power steering device 3000 according to the present example embodiment.

A vehicle such as an automobile generally has an electric power steering device. The electric power steering device 3000 according to the present example embodiment includes a steering system 520 and an auxiliary torque mechanism 540 that generates an auxiliary torque. The electric power steering device 3000 generates the auxiliary torque which assists a steering torque of the steering system that is generated when a driver operates the steering handle. The operational burden of the driver is reduced by the auxiliary torque.

The steering system 520 includes, for example, a steering handle 521, a steering shaft 522, universal shaft joints 523A and 523B, a rotating shaft 524, a rack and pinion mechanism 525, a rack shaft 526, left and right ball joints 552A and 552B, tie rods 527A and 527B, knuckles 528A and 528B, and left and right steering wheels 529A and 529B.

The auxiliary torque mechanism 540 includes, for example, a steering torque sensor 541, an automotive electronic control unit (ECU) 542, a motor 543, and a speed reduction mechanism 544. The steering torque sensor 541 detects the steering torque in the steering system 520. The ECU 542 generates a drive signal based on a detection signal of the steering torque sensor 541. The motor 543 generates the auxiliary torque corresponding to the steering torque based on the drive signal. The motor 543 transmits the generated auxiliary torque to the steering system 520 via the speed reduction mechanism 544.

The ECU 542 is, for example, the motor control device according to the first or second example embodiment. In an automobile, an electronic control system using the ECU as the core is constructed. In the electric power steering device 3000, for example, a motor drive unit is constructed by the ECU 542, the motor 543, and the inverter 545. The motor module 1000 according to the first or second example embodiment can be suitably used for the unit.

Example embodiments of the present disclosure can be widely used in various devices including various motors such as a vacuum cleaner, a dryer, a ceiling fan, a washing machine, a refrigerator, and an electric power steering device.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-18. (canceled)

19. A motor module comprising:
a motor including n-phase windings where n is an integer of three or more;
a first circuit board;
a first inverter mounted on the first circuit board and connected to the n-phase windings;
a first passive element group mounted on the first circuit board;
a first heat sink that is in thermal contact with the first circuit board;
a second circuit board;
a second inverter mounted on the second circuit board and connected to the n-phase windings; and
a second passive element group mounted on the second circuit board; wherein
a first passive element having a highest height in the first passive element group and a second passive element having a highest height in the second passive element group are located between the first circuit board and the second circuit board, and do not overlap each other when viewed along a direction of a rotation axis of a rotor of the motor.

20. The motor module according to claim 19, wherein
a first motor control device that controls a switching operation of a plurality of switching elements in the first inverter is mounted on a surface of the first circuit board where the first passive element is mounted; and
a second motor control device that controls a switching operation of a plurality of switching elements in the second inverter is further mounted on a surface of the second circuit board where the second passive element is mounted.

21. The motor module according to claim 19, wherein
a first motor control device that controls a switching operation of a plurality of switching elements in the first inverter is mounted on a surface of the first circuit board opposite to a surface on which the first passive element is mounted; and
a second motor control device that controls a switching operation of a plurality of switching elements in the second inverter is mounted on a surface of the second circuit board opposite to a surface on which the second passive element is mounted.

22. The motor module according to claim 20, wherein
the first motor control device includes a first drive circuit and a first control circuit that controls the first drive circuit; and
the second motor control device includes a second drive circuit and a second control circuit that controls the second drive circuit.

23. The motor module according to claim 20, wherein
a first power device group of the first inverter is mounted on the surface of the first circuit board where the first passive element is mounted; and
a second power device group of the second inverter is mounted on the surface of the second circuit board where the second passive element is mounted.

24. The motor module according claim 20, wherein
a first power device group of the first inverter is further mounted on a surface of the first circuit board opposite to the surface on which the first passive element is mounted; and
a second power device group of the second inverter is further mounted on a surface of the second circuit board opposite to the surface on which the second passive element is mounted.

25. The motor module according claim 20, wherein a shape of the first circuit board is identical to a shape of the second circuit board, and the first and second circuit boards have a common axis of symmetry.

26. The motor module according to claim 25, wherein
the first motor control device is located in a first area of the first circuit board and the first passive element group is located in a second area, the first area and the second area being divided by the axis of symmetry;
the second motor control device is located in a third area of the second circuit board, and the second passive element group is located in a fourth area, the third area and the fourth area being divided by the axis of symmetry; and
when viewed along the direction of the rotation axis of the rotor of the motor, the first area and the fourth area overlap each other, and the second area and the third area overlap each other.

27. The motor module according to claim 26, wherein
the first power device group is located in the second area of the first circuit board; and
the second power device group is located in the fourth area of the second circuit board.

28. The motor module according to claim 19, further comprising a second heat sink that is located between the first circuit board and the second circuit board and is in thermal contact with both the circuit boards.

29. The motor module according to claim 28, wherein
each of the first passive element and the second passive element is a capacitor; and
the second heat sink includes a concave portion that covers the first and second passive elements.

30. The motor module according to claim 22, wherein a connection of the motor is switchable to a Y connection using the first or second drive circuit.

31. The motor module according to claim 30, wherein after switching the connection of the motor to the Y connection, the motor is driven using a power supply voltage twice a power supply voltage before switching the connection of the motor.

32. The motor module according to claim 19, wherein the first inverter is connected to one end of each phase winding of the motor, and the second inverter is connected to another end of each phase winding of the motor.

33. The motor module according to claim 19, wherein
the n-phase windings includes a first coil set and a second coil set including ends that are Y-connected; and
the first inverter is connected to the first winding set, and the second inverter is connected to the second winding set.

34. The motor module according to claim 19, wherein the first circuit board is connected to a first power supply, and the second circuit board is connected to a second power supply.

35. The motor module according to claim 34, wherein the power supply voltage of the first power supply is higher than the power supply voltage of the second power supply.

36. An electric power steering device comprising:
a first power supply;
a second power supply; and
the motor module according to claim 34.
